(19) United States
(12) Patent Application Publication
(10) Pub. No.: US 2006/0015345 A1
(43) Pub. Date: Jan. 19, 2006

(54) Coordinated signal generation apparatus

(76) Inventor: Samuel N. Gasque, Hendersonville, NC (US)

Correspondence Address: GREGORY SMITH & ASSOCIATES, 3900 NEWPARK MALL ROAD, 3RD FLOOR, NEWARK, CA, 94560, US

(21) Appl. No.: 11/182,509

(22) Filed: Jul. 15, 2005

Related U.S. Application Data
(60) Provisional application No. 60/588,855, filed on Jul. 15, 2004.

(51) Int. Cl. G10L 21/06

(52) U.S. Cl. 704/276

(57) ABSTRACT

A portable signal generating device that, when activated, emits a visual or audible signal in coordination with other compatible devices in the vicinity that it can detect, and with which it can synchronize to create a coordinated signal effect.

### CROSS REFERENCE TO RELATED APPLICATIONS

This application claims the benefit of the priority date of provisional patent application Ser. No. 60/588,855 filed on Jul. 15, 2004, which is also herein incorporated by reference in its entirety.

### FIELD OF THE INVENTION

This invention relates generally to the field of devices as used to generate displays or make sounds, and more particularly for use by sports fans and booster clubs in support of their teams; and still more particular to a mobile device that communicates with other such devices to generating coordinated or complementary and interactive sounds and/or visual effects.

### BACKGROUND OF THE INVENTION

Part of the experience of sports fans comes from cheers, yells, acclamation and loud noise. There is an unspoken feeling that the louder the clamor the better chance of victory for the team. Sports fans from many generations and many countries show their support for a team by having inanimate replicas of the team's mascot, yelling the sounds made by the mascot animal, and displaying visual banners of their team. This experience is very emotional and enjoyable for the fans.

Often, fans and booster clubs use noise making devices, such as bells, whistles, horns, drums, and megaphones. Air horns and electric power horns have been used. Such devices have been popular as demonstrated by the quantity of devices that have been purchased over the many years that sporting events have occurred. As is known in the art, electronic sounds have been produced by various products using a variety of technologies such as records, audio tapes, compact discs, and digital signals stored in electronic memory.

The evolution of technology has allowed the continual enhancement of the experience for fans and now there is a need to make the experience more unified and coordinated. Typical preexisting technologies are only able to operate in a minimal way with their surroundings.

What is needed is an inexpensive device that could recognize the presence of other such peer devices and cooperatively interact with other such peer devices. The enhanced, shared experience provides a new level of enjoyment for the user of the device and for the many fans at the sporting event.

### SUMMARY OF THE INVENTION

The present invention includes a hand held apparatus that when activated, will display a visual effect and or emit a sound. Any desired sound may be used, for example, the apparatus may emit the animal call of a team mascot or team song. A feature in some embodiments of the device is its ability to detect and synchronize with other devices in the vicinity to create a coordinated visual effects or audio effect such as a pack of animals calling at once. The coordinated signaling by at least two such devices is a signal event.

In another embodiment, the present invention utilizes a microprocessor controlled RF circuit for synchronization purposes. The device also may have an adjustable volume control and may comfortably fit in the palm of the operator's hand. In some embodiments the invention operates using a portable battery supply that is able to last throughout a complete game including any overtime activity. In some embodiments the apparatus is housed in a durable and weatherproofed enclosure allowing its protection in event of rain.

In some embodiments, the device is able to produce an authentic animal sound and in a preferred embodiment, the sound is loud enough to be heard by others in large gatherings. In another aspect of the invention, the device is also able to produce visual effects that may include at least a single light source and, in alternate embodiments, can including moving light sources such as rotating beacons, flat images, or three dimensional images.

In still another aspect of the invention, the device is able to identify the presence of other such devices in its proximity. For example, when synchronized with other devices, the devices could cooperate to produce a coordinated signal made up of the individual signals from a plurality of devices of the invention to create a signal event. For example, when synchronized with other devices, the devices could cooperate to produce the sound effect of a pack of animals operating in slightly different times, do a simultaneous sound, or a sound that appeared to be passed from device to device.

In yet another aspect of the invention, the device could be controlled from a centralized device that would affect the entire venue. The purpose being to deactivate some or all devices when authorities so require, activate some or all devices when deemed appropriate, or act as a synchronization source to coordinate the activities of some or all devices.

### BRIEF DESCRIPTION OF THE DRAWINGS

A better understanding of the present invention will be had upon reference to the accompanying drawings in which like numerals refer to like parts in the several views and in which:

FIG. 1 contains the major system components

FIG. 2 is a block diagram of the major sonic sub-system components

FIG. 3 is a block diagram of the major visual sub-system components

### DETAILED DESCRIPTION

The present invention includes a signal generating apparatus which is a sports novelty device that may include a high volume sound output for playing a selected sound, for example, the sound or call of a sports team's mascot. The signal generating apparatus, may further be able to synchronize with other devices in the local area to create a coordinated sound or visual effect. For example, for North Carolina State University which has a wolf as its mascot, the signal generating apparatus would mimic a pack of wolves calling at the same time. In essence, devices would detect the presence of other such devices and be able to participate in generating coordinated sounds. The signal generating apparatus may include but is not limited to electronic circuitry including printed circuit boards and electro-mechanical devices.

The embodiment of the invention discussed in detail herein is meant to be a general purpose device to be used in a variety of situations. While a preferred embodiment is to reproduce the sound of a sport's team mascot, its teachings should not be limited to such applications. Alternate embodiments include, but not limited to, applications in hunting, exercising, zoos, wildlife, or law enforcement.

In one embodiment, a home version of the present invention allows for the device to produce sounds such as, but not limited to, friendly animals, cars, jets, or construction equipment. After many hours of delight, the adults in the vicinity may grow weary of the child's exuberance and wish to have the toy silenced. Instead of having the adult deactivate the toy manually, the toy will be a remotely disabled through the wireless interface. Such a useful feature called a “sanity button” avoids a physical altercation that might arise with the child while trying to silence the toy.

In still another alternate embodiment, a “rival switch” is present on the signal generating apparatus and this mode can be activated by the user. Since the user desires to support his team by the generation of sounds by the signal generating apparatus, the user may also wish to antagonize the opposing team through the use of sound or visual events. When activated, the rival switch would take the sound from the opposing team and produce a sound that mocked the opposing team. An example of the mocking sound would be for a team that has a tiger for their mascot and the mascot would normally produce a loud roaring sound. The signal generating apparatus in mocking would produce the sound of a mild kitten. In an alternate embodiment, a separate master controller would be able to selectively activate the signal generating apparatus that would produce the mocking events.

Coordinated as used herein includes signals from two or more signal generating apparatus including any combination of signal type having a timing and duration that are synchronized to produce a desired signal event effect.

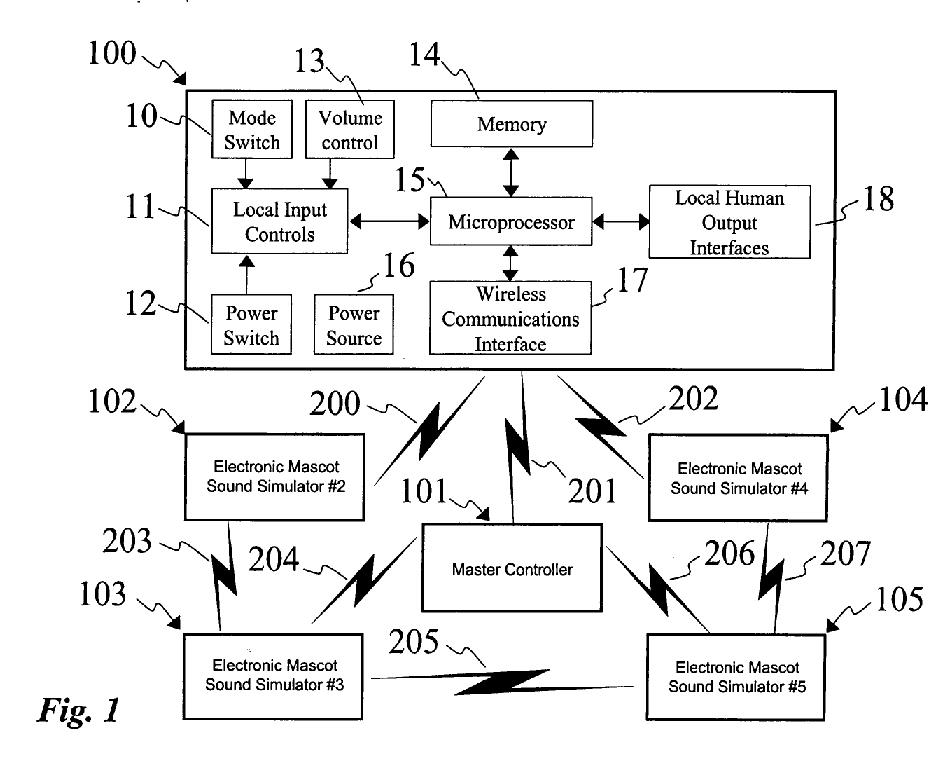

Referring to FIG. 1, the general components of a system of the present invention are signal generating apparatus 100 and at least one compatible signal generating apparatus device 102 and optionally a plurality of signal generating apparatus including 103, 104, and 105. There may be an optional master controller 101 present. signal generating apparatus 100 and signal generating apparatus 102 are able to wirelessly identify the presence of the other device.

In an alternate embodiment, the master controller 101 is present at the sports venue and this controller allows event supervisors the ability to enable, disable, synchronize, or selectively control all such signal generating apparatus. Although there is no requirement for a master controller to be present to make use of the present invention, the added features enabled by the controller add useful functionality to the system. There may be times that event supervisors wish to have silence at the venue such as during the national anthem. The master controller would disable all such signal generating apparatus and prevent an audio disturbance.

The wireless technology used for the identification or other devices in the vicinity may be, but not limited to, sonic, Radio Frequency (RF), or infrared (IR) technologies. In the preferred embodiment the wireless technology allows for bi-directional communication between the devices. In an alternate embodiment, uni-directional communication is used. Examples of useable wireless technologies include but are not limited to a form of IEEE 802.11 332, a form of Bluetooth 336, a form of IEEE 802.15 338, and a form of IEEE 802.16 334.

The operation of an example embodiment of the invention is as follows. A person wishing to express their exuberance for their team may activate a function on signal generating apparatus 100 which would create a sound signal such a wolf howling. Signal generating apparatus 100 would contemporaneously send a communication on communications path 200 indicating its activation. In a preferred mode, signal generating apparatus 102 would recognize the communication sent wirelessly from signal generating apparatus 100 and also activate its sound signal. The communication would continue to be relayed in kind to signal generating apparatus 103, 104, and 105. Thus, all the signal generating apparatus would be creating compatible sound signals which together create the desired signal event. In a second preferred mode, signal generating apparatus 102, 103, 04, and 105 may vary the starting of their sound events so that effect generated may be that of several individual wolves starting and stopping at differing times and producing slightly different sounds. Any useable methods for synchronizing the signal events may be used in the invention. For example, when it is desired to initiate a single simultaneous sound event from sound generating apparatus 100, and 102-105, one method for synchronizing the sound events may include transmitting a signal from signal generating apparatus 100 that is received by signal generating apparatus' 102-105, which causes all of the signal generating apparatus' 100 and 102-105 to begin a sound event at the same time.

In an alternate embodiment, the sound event may be enhanced by or replaced by a visual event such as an activation of a light. There is no requirement that all other signal generating apparatuses posses the same capability of generating a sound event, visual event, or both events simultaneously. In one alternate embodiment, a signal generating apparatus may posses neither sound nor visual event capabilities but its presence would allow for the signal generating apparatus to relay trigger messages between devices that do posses such capabilities.

The wireless technology used by master controller 101 to communicate with signal generating apparatus 100 may be, but is not limited to, sonic, Radio Frequency (RF), or infrared (IR) technologies. The communication technology between signal generating apparatus 100 and its peer signal generating apparatus 102 is the same wireless technology as between signal generating apparatus 100 and master controller 101 in the preferred embodiment. In an alternate embodiment, the communication technology between signal generating apparatus 100 and its peer signal generating apparatus 102 is a different wireless technology than is used between signal generating apparatus 100 and master controller 101. In the preferred embodiment the wireless technology from the master controller is unidirectional. In an alternate embodiment, bidirectional communication is used.

In an embodiment where master controller 101 is present, the controller is able to control the activation of the sound and visual events of all the signal generating apparatus at the venue. In an alternate embodiment the controller acts as a coordinator of the sound or visual events occurring in the plurality of signal generating apparatus devices. Examples of such coordination are, but not limited to, sending a signal that initiates an action that moves progressively through the venue mimicking a “wave” action, having select signal generating apparatus activate to mimic a pack of mascots instead of a single unified mascot, or causing select signal generating apparatus to vary their output events differently from neighboring signal generating apparatus.

The major functional blocks within signal generating apparatus 100 that are required to implement the features of the resent invention are: a local power source 16, microprocessor 15 that manages the output events through block 18 based on the user input received sensed by block 11, and sensing of other external devices through messages being passed through the wireless communications interface 17. The sequence of instructions for the microprocessor are stored in memory 14. A preferred embodiment has the functional blocks housed in a portable, durable enclosure that is weatherproofed allowing its protection in event of rain.

Power source 16 in the preferred embodiment is a primary cell battery that is replaceable when the energy in the cell is exhausted. In an alternate embodiment, a rechargeable battery is present that is designed to last for at least the duration of the sporting event including the additional time when the event goes into single or multiple overtime periods. In still other embodiments, a fuel cell may be used. In yet other embodiments, the local power can be, but not limited to, being received from solar power, RF signals, magnetic signals, optical signals, or any combination of the power sources.

The wireless communications interface 17 may be implemented in a variety of technologies and the usage of any such technology is intended to be within the scope of the presents invention. In the preferred embodiment, signal generating apparatus 100 uses a Radio Frequency (RF) technology communicate with other similar devices and the same RF technology also communicates between signal generating apparatus 100 and master controller 101. Alternate wireless technologies include, but not limited to, sonic, ultrasonic, infrared, magnetic, or visible light technologies. In still other alternate embodiments, the wireless technology between signal generating apparatus 100 and other similar units is not the same as the wireless technology between signal generating apparatus 100 and master controller 101.

The Local Human Output Interface 18 consists of an optical output, sonic or sound output or both a sound and optical output that can be sensed by a person. In an alternate embodiment where signal generating apparatus 100 acts as a relay device for wireless messages, block 18 may optionally be present. Control of these output interface technologies is available to the microprocessor through block 11 that connects to settings that may be altered by the user and/or master controller 101. Examples of such settings are, but not limited to, a volume control, the type of output event, the sequencing of the output event, or some modes of operation.

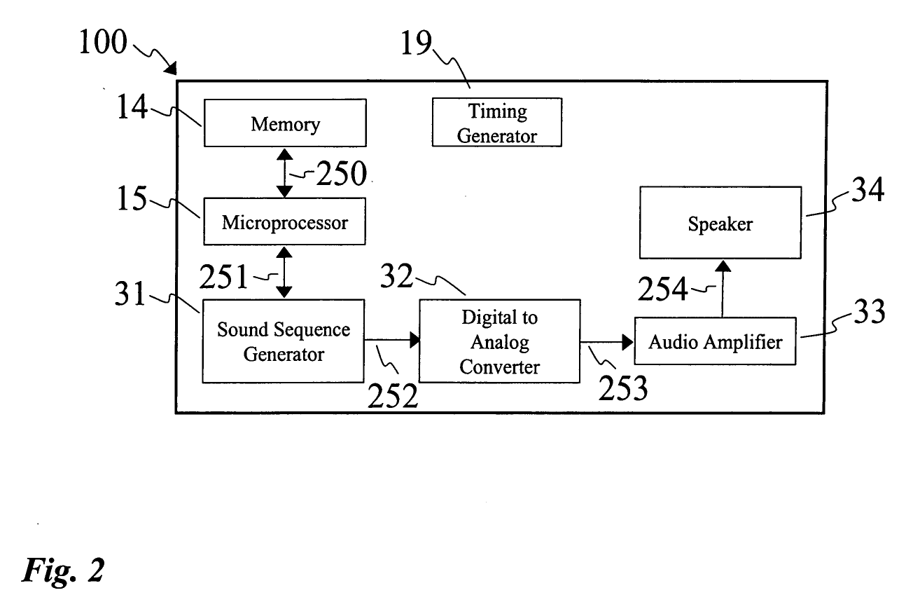

The schematic of the sonic or sound portion of the Human Output Interface 18 is shown with more detail in FIG. 2. There is an electronic sound sequence generator 31 that is able to create an electronic waveform connected to digital-to-analog converter 32, and sent to amplifier 33 that is able to drive speaker 34. Many suitable or useable technologies and methods are known for use in block 31 to implement its function. Any suitable technology or method is intended to be within the scope of the present invention. The electronic waveform can be generated with sequences initiated over the communications path 251 by microprocessor 15 upon reading memory 14 over communications pathway 250 in the preferred embodiment. In alternate embodiments, the waveform is generated through information within block 31, or in yet another alternate embodiment, information received from the wireless interface.

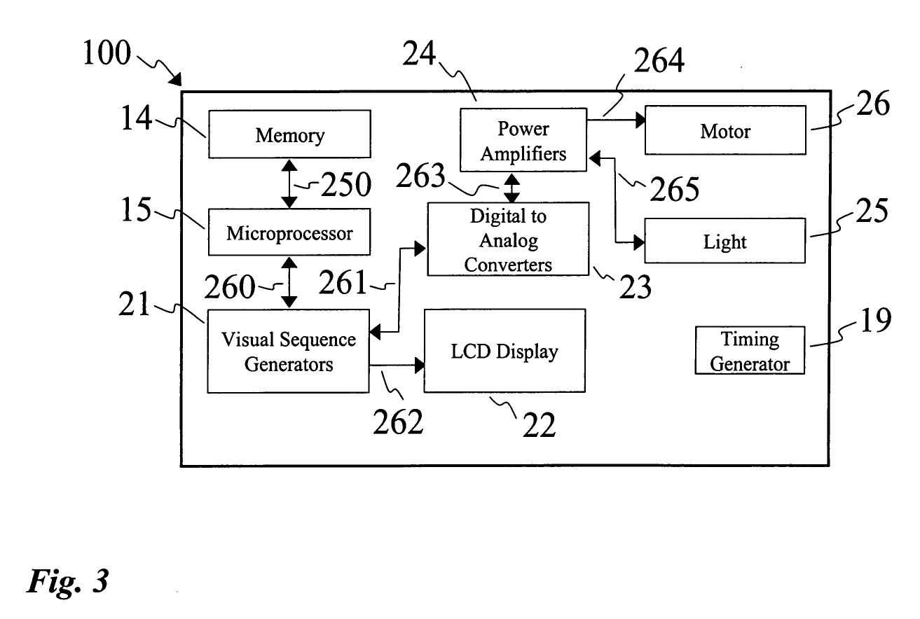

The schematic of the visual portion of the Human Output Interface 18 is shown with more detail in FIG. 3. There is an electronic visual sequence generator 21 that is able to create an electronic waveform connected to digital-to-analog converters 23, and sent to amplifiers 24 that are able to light 25. In an alternate embodiment, motor 26 under the control of Visual Sequence generator 21, is mechanically adapted to drive light 25 to alter the visual effect. In yet another alternate embodiment, Micro Electro-Mechanical Systems (MEMS) may integrate the visual and mechanical blocks functions. In yet still other alternate embodiments, a more complex, visual image is available for the enjoyment of the users by viewing LCD display 22. Display 22 is under the control of block 21 via communications path 262.

Many suitable or useable technologies and methods are known for use in block 21 to implement its function. Any suitable technology or method is intended to be within the scope of the present invention. The electronic waveform can be generated with sequences initiated over the communications path 260 by microprocessor 15 upon reading memory 14 over communications pathway 250 in the preferred embodiment. In alternate embodiments, the waveform is generated through information within block 21, or in yet another alternate embodiment, information received from the wireless interface.

Although exemplary embodiments of the invention have been described in detail above, those skilled in the art will readily appreciate that many additional modifications are possible without departing materially from the teachings and advantages of the invention. For example, the system may be used in hunting where the system can simulate the sounds of a heard of animals to lure an animal into a desired location.

What is claimed is:

1. A system for the generation of a signal event comprising in combination:
at least two signal generating apparatus capable of emitting at least one signal, each said signal generating apparatus capable of communicating to other said signal generating apparatus, whereby activation of one of said at least two signal generating apparatus causes said one of said at least two signal generating apparatus to emit a communication that may be received by other of said at least two signal generating apparatus, causing said one of said at least two signal generating apparatus and said other of said at least two signal generating apparatus to each generate a signal which together comprise a coordinated signal event.

2. The system of claim 1, wherein said at least one signal comprises at least one signal type selected from the group consisting of: an audible signal, a visual signal, a tactile signal.

3. The system of claim 1, wherein said signal type comprises at least one audible sports team related signal.

4. The system of claim 3, wherein said signal event mimics at least one sound of a mascot of a sports team.

5. The system of claim 1 wherein each said signal generating apparatus includes at least two active states, said at least two active states including an automatic state wherein
said signal generating apparatus will respond to communications from other signal generating apparatus to emit said signal as part of said coordinated signal event, and a from other signal generating apparatus to emit said signal as part of said coordinated signal event when said signal generating apparatus is manually activated by a user during a duration of said coordinated signal event.

6. The system of claim 1 further comprising a master communication apparatus.

7. The system of claim 6 wherein each said signal generating apparatus further includes an externally controlled state in which said signal event may only be initiated by a communication received from said master controller.

8. The system of claim 6 wherein each said signal generating apparatus further includes an externally controlled state in which said coordinated signal event may also be initiated by a communication received from said master controller.

9. The system of claim 7 wherein a communication from said master communication apparatus received by said at least two signal generating apparatus will cause said at least two signal generating apparatus to enter said externally controlled state.

10. A system for the generation of a signal event comprising in combination:
at least two signal generating apparatus each capable of emitting at least one signal, and wherein activation of one of said at least two signal generating apparatus causes said one of said at least two signal generating apparatus to emit a communication that may be received by other of said at least two signal generating apparatus, causing said one of said at least two signal generating apparatus and said other of said at least two signal generating apparatus each generate a signal which together comprise a coordinated signal event.
a master communication apparatus, capable of emitting a communication that may be received by said at least two signal generating apparatus, causing said at least two signal generating apparatus to each generate a signal which together comprise a coordinated signal event.

11. The system of claim 10 wherein said at least one signal comprises at least one signal type selected from the group consisting of: an audible signal, a visual signal, a tactile signal.

12. The system of claim 10 wherein said signal type comprises at least one audible sports team related signal.

13. The system of claim 12 wherein said signal event mimics at least one sound of a mascot of a sports team.

14. The system of claim 10 wherein each said signal generating apparatus includes at least two active states, said at least two active states including an automatic state wherein said signal generating apparatus will respond to communications from other signal generating apparatus to emit said signal as part of said coordinated signal event, and a manual state wherein said signal generating apparatus will respond to communications from other signal generating apparatus to emit said signal as part of said coordinated signal event when said signal generating apparatus is manually activated by a user during a duration of said coordinated signal event.

15. The system of claim 10 wherein each said signal generating apparatus includes an externally controlled state in which said signal event may only be initiated by a communication received from said master controller.

16. The system of claim 15 wherein a communication from said master communication apparatus received by said at least two signal generating apparatus will cause said at least two signal generating apparatus to enter said externally controlled state.

17. A system for the generation of an audible sports team related signal event comprising in combination:
at least two signal generating apparatus capable of emitting at least one signal, each said signal generating apparatus capable of communicating to other said signal generating apparatus,
whereby activation of one of said at least two signal generating apparatus causes said one of said at least two signal generating apparatus to emit a communication that may be received by other of said at least two signal generating apparatus, causing said one of said at least two signal generating apparatus and said other of said at least two signal generating apparatus to each generate an audible signal which together comprise a coordinated audible signal event.

18. The system of claim 17 wherein each said signal generating apparatus includes at least two active states, said at least two active states including an automatic state wherein said signal generating apparatus will respond to communications from other signal generating apparatus to emit said signal as part of said coordinated signal event, and a manual state wherein said signal generating apparatus will respond to communications from other signal generating apparatus to emit said signal as part of said coordinated signal event when said signal generating apparatus is manually activated by a user during a duration of said coordinated signal event.

19. The system of claim 18 further comprising a master communication apparatus.

20. The system of claim 19 wherein each said signal generating apparatus further includes an externally controlled state in which said signal event may only be initiated by a communication received from said master controller.
